(19) United States
(12) Patent Application Publication
(10) Pub. No.: US 2022/0026558 A1
(43) Pub. Date: Jan. 27, 2022

(54) MONITORING VEHICLE MOTION USING SURFACE-PENETRATING RADAR SYSTEM AND DOPPLER SHIFTS

(71) Applicants: Connor QUINN, Somerville, MA (US); Bryan J. FOX, Wellesley, MA (US); Sanford FREEDMAN, Chelmsford, MA (US); Daniel JAMISON, Derry, NH (US); Byron STANLEY, Newton, MA (US)

(72) Inventors: Connor QUINN, Somerville, MA (US); Bryan J. FOX, Wellesley, MA (US); Sanford FREEDMAN, Chelmsford, MA (US); Daniel JAMISON, Derry, NH (US); Byron STANLEY, Newton, MA (US)

(21) Appl. No.: 17/382,717

(22) Filed: Jul. 22, 2021

Related U.S. Application Data
(60) Provisional application No. 63/055,485, filed on Jul. 23, 2020.

(51) Int. Cl. G01S 13/60; G01S 13/88

(52) U.S. Cl. CPC G01S 13/60; G01S 13/885

(57) ABSTRACT

Doppler analysis of surface-penetrating radar signals are utilized to compute or estimate parameters associated with vehicle motion. The Doppler shift may originate with reflections from subsurface or above-surface features ahead of (or behind) the moving vehicle, in which case a vehicle speed may be computed from the shift; or may originate with reflections from surface or subsurface features directly below the vehicle, in which case the shift corresponds to a vertical speed that may be used to sense the performance of, or changes in, the vehicle's suspension system.

### CROSS-REFERENCE TO RELATED APPLICATION

This application claims priority to and the benefit of, and incorporates herein by reference in its entirety, U.S. Ser. No. 63/055,485, filed on Jul. 23, 2020.

### FIELD OF THE INVENTION

The present invention relates, generally, to vehicle route planning and, more particularly, to vehicle route planning using surface-penetrating radar (SPR) systems.

### BACKGROUND

Various navigation systems have been developed to provide vehicle drivers with route planning between a specified originating location and a destination location. Generally, one or more routes are selected from a large database of roads. The navigation system typically includes one or more position-determining devices, such as a global positioning system (GPS) receiver, to indicate the current position of the vehicle relative to roads in the database. Conventionally, route planning is performed based on certain user-specified criteria, such as the shortest distance or fastest travel time. In off-road conditions, where vehicles are driven on unsurfaced roads or tracks—which may feature sand, gravel, mud, snow, rocks and other natural terrain—route planning utilizing conventional techniques remains challenging. For example, off-road travel may require specially equipped vehicles depending on the conditions and terrain; such considerations, however, are not taken into account by the conventional navigation techniques.

As described in U.S. Pat. No. 8,949,024, the entire disclosure of which is hereby incorporated by reference, SPR images of surface and subsurface features along a vehicle's path may be obtained and analyzed to localize the vehicle. In particular, a current vehicle location may be established based on locations associated with previously acquired SPR images. For example, new SPR images may be compared with previously acquired SPR images using image correlation or other suitable technique.

Although this approach can provide accurate location information, the amount of processing involved in correlating images generally precludes using SPR localization technology to determine the speed of the vehicle. In contrast, GPS systems can report speed using two GPS points (locations) and the GPS receiver clock (which is very accurate, synchronizing regularly with the atomic clocks aboard GPS satellites).

### SUMMARY

Embodiments of the present invention utilize Doppler analysis of SPR signals to compute or estimate parameters associated with vehicle motion. The Doppler shift may originate with reflections from subsurface or above-surface features ahead of (or behind) the moving vehicle, in which case a vehicle speed may be computed from the shift; or may originate with reflections from surface or subsurface features directly below the vehicle, in which case the shift corresponds to a vertical speed that may be used to sense the performance of, or changes in, the vehicle's suspension system.

Accordingly, in a first aspect, the invention relates to a navigation system comprising, in various embodiments, an SPR (e.g., a ground-penetrating radar (GPR)) system; an image-generation module for processing signals from the SPR system into images including subsurface features; a navigation system for determining a location based on the images generated by the image-generation module and a library of reference SPR images; a Doppler filter for extracting a Doppler shift from signals from the SPR system; and a speed-computation module for determining at least one of a vertical or a horizontal speed from the extracted Doppler shift.

The SPR system may comprise a plurality of antenna elements angled to produce a horizontal Doppler shift component during horizontal motion, and the speed-computation module may be configured to compute a horizontal travel speed from the horizontal Doppler shift component. In some embodiments, the SPR system comprises a plurality of antenna elements angled to produce a vertical Doppler shift component during vertical motion. The speed-computation module may be configured to compute at least one motion parameter from the vertical Doppler shift component.

In various embodiments, the further comprises a terrain-monitoring module for determining terrain characteristics from the images generated by the image-generation module, and the speed-computation module may be further configured to assess suspension performance based at least in part on the terrain characteristics and the motion parameter(s). In some embodiments, the speed-computation module is further configured to assess suspension performance based at least in part on a motion parameter. The horizontal speed may be computed based at least in part on Doppler spreading.

In another aspect, the invention pertains to a method of navigation. In various embodiments, the method comprises the steps of computationally processing signals received from an SPR system integrated with a vehicle into images including subsurface features; computationally determining a location based on the images and a library of reference SPR images; extracting a Doppler shift from the signals from the SPR system; and determining at least one of a vertical or a horizontal speed from the extracted Doppler shift.

The signals may be received by a plurality of antenna elements angled to produce a horizontal Doppler shift component during horizontal motion of the vehicle and the method may further include computing a horizontal travel speed from the horizontal Doppler shift component. Alternatively or in addition, the signals may be received by a plurality of antenna elements angled to produce a vertical Doppler shift component during vertical motion, in which case the method may comprise the step of computing at least one motion parameter from the vertical Doppler shift component.

In some embodiments, the method may further comprise the steps of determining terrain characteristics from the images and assessing suspension performance based at least in part on the terrain characteristics and motion parameter(s). The horizontal speed may be computed based at least in part on Doppler spreading.

As used herein, the term “substantially” means ±10%, and in some embodiments, ±5%. Reference throughout this specification to “one example,” “an example,” “one embodiment,” or “an embodiment” means that a particular feature, structure, or characteristic described in connection with the example is included in at least one example of the present technology. Thus, the occurrences of the phrases “in one example,” “in an example,” “one embodiment,” or “an embodiment” in various places throughout this specification are not necessarily all referring to the same example. Furthermore, the particular features, structures, routines, steps, or characteristics may be combined in any suitable manner in one or more examples of the technology. The headings provided herein are for convenience only and are not intended to limit or interpret the scope or meaning of the claimed technology.

### BRIEF DESCRIPTION OF THE DRAWINGS

The foregoing and the following detailed description will be more readily understood when taken in conjunction with the drawings, in which:

FIG. 1A schematically illustrates an exemplary traveling vehicle including a terrain monitoring system in accordance with embodiments of the invention.

FIG. 1B schematically illustrates an alternative configuration in which the antenna of the terrain monitoring system is closer to or in contact with the surface of the road.

FIG. 2 schematically depicts an exemplary architecture system in accordance with embodiments of the invention.

### DETAILED DESCRIPTION

As is well known, the Doppler effect (or Doppler shift) is the change in frequency of a wave in relation to an observer moving relative to the wave source. Radar speed detectors direct microwave radiation toward moving vehicles and detect the reflected waves, which are shifted in frequency by the Doppler effect; this shift corresponds to the vehicle speed, and the relative speed between source and target can be computed. In particular, Doppler frequency shift of an echo signal reflected from a moving target is given as

$${f}_{D} = \frac{2 v cos θ}{λ} \qquad Eq . ( 1 )$$

where f_{D} is the frequency shift in Hz, v is the velocity of the target, λ is the wavelength of the signal, and θ is the angle defined by the target's direction of travel and the radar line of sight to the target. Speed computation from Doppler shifts is described, for example, in U.S. Pat. No. 7,136,736, the entire disclosure of which is hereby incorporated by reference.

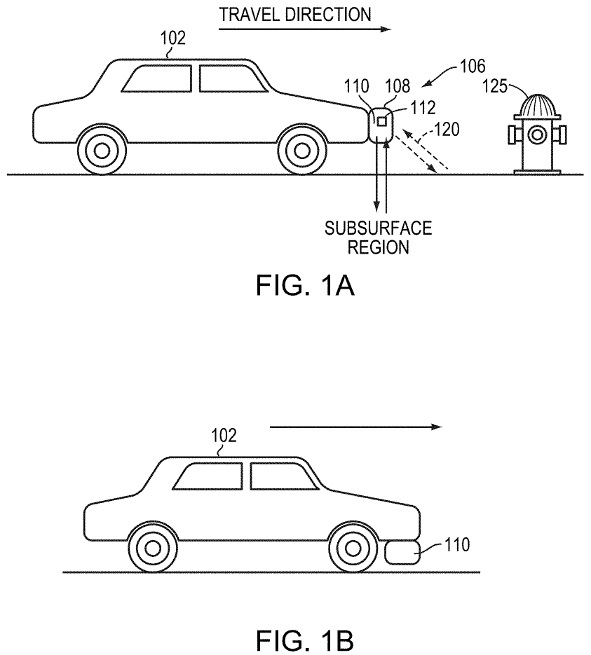

FIG. 1A depicts an exemplary vehicle 102 traveling on a predefined route 104; the vehicle 102 is provided with a terrain-monitoring system 106 for vehicle navigation in accordance herewith. In various embodiments, the terrain monitoring system 106 includes an SPR system 108 having a ground-penetrating radar (GPR) antenna array 110 fixed to the front (or any suitable portion) of the vehicle 102. The GPR antenna array 110 is generally oriented parallel to the ground surface and extends perpendicular to the direction of travel. In an alternative configuration, the GPR antenna array 110 is closer to or in contact with the surface of the road (FIG. 1B). In one embodiment, the GPR antenna array 110 includes a linear configuration of spatially-invariant antenna elements for transmitting GPR signals to the road; the GPR signals may propagate through the road surface into the subsurface region and be reflected in an upward direction. The reflected GPR signals can be detected by the receiving antenna elements in the GPR antenna array 110. In various embodiments, the detected GPR signals are then processed and analyzed to generate one or more SPR images (e.g., GPR images) of the subsurface region along the track of the vehicle 102. If the SPR antenna array 110 is not in contact with the surface, the strongest return signal received may be the reflection caused by the road surface. Thus, the SPR images may include surface data, i.e., data representing the interface of the subsurface region with air or the local environment.

For localization, the SPR images may be compared to SPR reference images that were previously acquired and stored for subsurface regions that at least partially overlap the subsurface regions for the defined route. The image comparison may be a registration process based on, for example, correlation; see, e.g., the '024 patent mentioned above and U.S. Pat. No. 8,786,485, the entire disclosure of which is incorporated by reference herein. The location of the vehicle 102 can then be determined based on the comparison.

In addition, the location data determined based on comparison of the acquired SPR images and SPR reference images may be used to create a location map including the routes that the vehicle 102 has traveled. Additionally or alternatively, the location data for the vehicle 104 may be used in combination with the data provided by an existing map (e.g., supplied by GOOGLE MAP) and/or one or more other sensors or navigation systems, such as an inertial navigation system (INS), a GPS, a sound navigation and ranging (SONAR) system, a light detection and ranging (LIDAR) system, a camera, an inertial measurement unit (IMU) and an auxiliary radar system, to guide the vehicle 102. For example, the controller 112 may localize the obtained SPR information to an existing map generated by the GPS. Approaches for utilizing the SPR system for vehicle navigation and localization are described in, for example, in the '024 patent.

Embodiments of the invention extract a Doppler signal from the returned GPR signal. A Doppler filter can be employed for this purpose, and may be implemented either as hardware by resonance filters or after the digitization of the received signals as a software routine. The filter may have a high enough sample rate to distinguish 20 Hz for a center frequency of 250 MHz for a vehicle travelling at 55 mph, for example. The filter can then be added to the processing of the raw data coming through, for example, an analog-to-digital converter.

If the elements of the antenna array 110 are arranged so that the GPR signal is emitted substantially vertically (i.e., perpendicular to the direction of vehicle travel), the Doppler signal indicates the vertical velocity. This velocity may be used to detect deficiencies or anomalies in the vehicle's suspension system, either as an absolute peak measure, averaged over time (since weak suspension will allow too much “bounce” on average), or considered relative to the terrain. For example, as described in U.S. Patent Publ. No. 2021/0018323, which is hereby incorporated by reference in its entirety, GPR can be used in a terrain-monitoring system capable of tracking the roughness of the terrain over which the vehicle travels. This monitored roughness can be considered in scoring the performance of the vehicle's suspension system based on an expected level of bounce given the terrain. Bounce is typically specified by three parameters: bounce overshoot, settling time, and frequency, reflecting the damped harmonic oscillation. This is sometimes referred to as a bounce transient response.

Depending on the orientation of the elements of the antenna array 110, the radar signal may include a horizontal component as indicated at 120 in FIG. 1A. This horizontal component may strike and reflect off subterranean features or surface features (e.g., a fire hydrant 125) to produce a Doppler signal indicative of the vehicle's travel speed. The Doppler signal will contain both vertical and horizontal components corresponding to vehicle bounce and travel velocity. At typical driving speeds, the Doppler shift will be quite different for these two components, which can be extracted separately.

In particular, travel velocity may manifest as Doppler spreading (forward and backward). Vertical velocity may also be extracted but may be challenging to measure at low frequencies. The horizontal and vertical components may be differentiable based on a bias offset of a Doppler-spreading fast Fourier transform or based on timing of the resulting returns. By filtering the returns to compensate for angular ground-reflection times, longer return times from the surface can indicate the wider angles and Doppler spreading. Shorter return times indicate a closer surface and represent the vertical Doppler return.

The Doppler spread will depend on the beamwidth and shape of the antenna pattern and will generally include a positive portion and a negative portion (in front of the car, the Doppler shift will be positive, while behind the car the Doppler shift will be negative). The velocity may be determined from this spread either via straightforward computation or by associating the spread with a velocity from data taken previously. Any number of conventional frequency estimation methods could be employed, including but not limited to the Fourier transform, Pisarenko's method, MUSIC or the Eigenvector method.

In addition to instantaneous returns from the Doppler effect, velocity can be measured by observing the returns over time, i.e., measuring the angle of the hyperbola formed in a GPR image (with the x-axis as time) and comparing it to the angle of the hyperbola formed in the map at a known velocity, for reference. A steeper hyperbola indicates faster speed. Moreover, known surface landmarks (e.g., a manhole cover of known diameter) may be used in a similar way, measuring velocity as the object passes. Simply having scaling information of the observed object and the distance from the sensor may be sufficient to compute velocity.

Measurements of GPR-based changes in position may also be obtained and averaged with Doppler-based velocity measurements. In particular, the change in position can be computed from the GPR data and the velocity computed by dividing by the time interval, and this can be averaged or otherwise combined with Doppler measurements of velocity (and/or other available measurements) in a navigation filter.

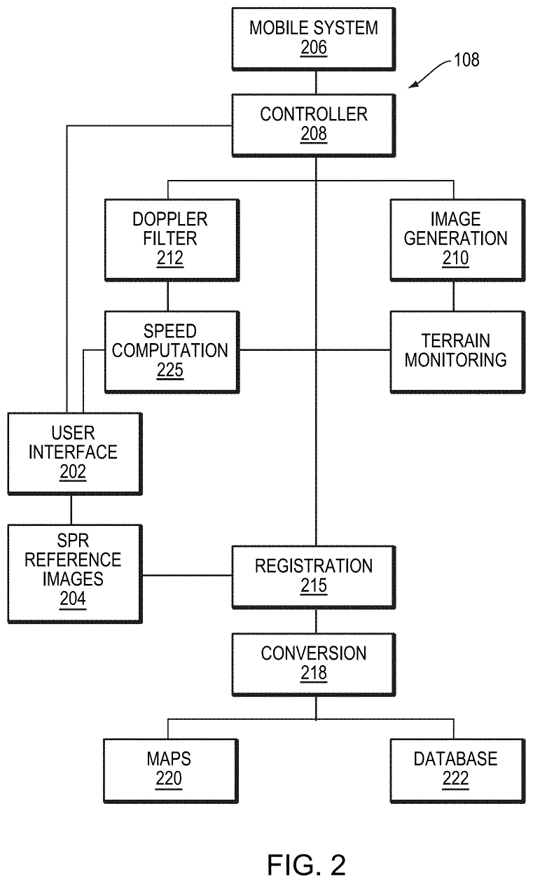

FIG. 2 depicts an exemplary terrain-monitoring system (e.g., the SPR system 108) implemented in a vehicle 102 for providing an optimal route in accordance herewith. To facilitate navigation, the SPR system 108 may include a user interface 202 through which a user can enter data to define a route, or select a predefined route. SPR images are retrieved from an SPR reference image source 204 according to the route. The SPR system 108 also includes a mobile SPR system (“Mobile System”) 206 having an SPR antenna array 110. The transmit operation of the mobile SPR system 206 is controlled by a controller (e.g., a processor) 208 that also receives the return SPR signals detected by the SPR antenna array 110. The controller 208 includes or communicates with an image-generation module 210 that generates SPR images of the subsurface region below the road surface and/or the road surface underneath the SPR antenna array 110 in accordance, for example, with the '024 and '485 patents mentioned above. The SPR image includes features representative of structure and objects within the subsurface region and/or on the road surface, such as rocks, roots, boulders, pipes, voids and soil layering, and other features indicative of variations in the soil or material properties in the subsurface/surface region. The controller 208 also includes or communicates with a conventional Doppler filter 212.

In various embodiments, a registration module 215 compares the SPR images provided by the module 210 to the SPR images retrieved from the SPR reference image source 204 to determine the location of the vehicle 102 (e.g., the offset of the vehicle with respect to the closest point on the route). The locational information (e.g., offset data, or positional error data) determined in the registration process may be provided to a conversion module 218 that creates a location map for navigating the vehicle 102. For example, the conversion module 218 may generate GPS data corrected for the vehicle positional deviation from the route. Alternatively, the conversion module 218 may retrieve an existing map from a map source 220 (e.g., other navigation systems, such as GPS, or a mapping service), and then localize the obtained locational information to the existing map. In one embodiment, the location map of the predefined route is stored in a database 222 in system memory and/or a storage device accessible to the controller 208.

The Doppler filter 212 extracts the horizontal and/or vertical Doppler shifts from the returned GPR signal. A speed-computation module 225 calculates the vehicle's travel speed based on the horizontal component and Eq. 1; in some embodiments, it provides this value to the user interface 202 for display to the user. In addition, the computation module 225 may calculate the vehicle's bounce from the vertical Doppler shift.

A terrain-monitoring module 230 analyzes the images generated by the module 210 in accordance with the '8323 application mentioned above to characterize the terrain over which the vehicle is currently traveling. The speed-computation module 225 may score the performance of the vehicle's suspension system based on the computed vertical velocity and the observed terrain, and issue an alert to the driver via the user interface 202 if the score is outside prescribed limits. Alternatively or in addition, the computed score may be stored routinely at intervals for diagnostic purposes.

The controller 208, image-generation module 210 and the Doppler filter 212 implemented in the vehicle may include one or more modules implemented in hardware, software, or a combination of both. For embodiments in which the functions are provided as one or more software programs, the programs may be written in any of a number of high level languages such as PYTHON, FORTRAN, PASCAL, JAVA, C, C++, C#, BASIC, various scripting languages, and/or HTML. Additionally, the software can be implemented in an assembly language directed to the microprocessor resident on a target computer; for example, the software may be implemented in Intel 80×86 assembly language if it is configured to run on an IBM PC or PC clone. The software may be embodied on an article of manufacture including, but not limited to, a floppy disk, a jump drive, a hard disk, an optical disk, a magnetic tape, a PROM, an EPROM, EEPROM, field-programmable gate array, or CD-ROM. Embodiments using hardware circuitry may be implemented using, for example, one or more FPGA, CPLD or ASIC processors.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive.

What is claimed is:

1. A navigation system comprising:
a surface-penetrating radar (SPR) system;
an image-generation module for processing signals from the SPR system into images including subsurface features;
a navigation system for determining a location based on the images generated by the image-generation module and a library of reference SPR images;
a Doppler filter for extracting a Doppler shift from signals from the SPR system; and
a speed-computation module for determining at least one of a vertical or a horizontal speed from the extracted Doppler shift.

2. The system of claim 1, wherein the SPR system comprises a plurality of antenna elements angled to produce a horizontal Doppler shift component during horizontal motion.

3. The system of claim 2, wherein the speed-computation module is configured to compute a horizontal travel speed from the horizontal Doppler shift component.

4. The system of claim 1, wherein the SPR system comprises a plurality of antenna elements angled to produce a vertical Doppler shift component during vertical motion.

5. The system of claim 4, wherein the speed-computation module is configured to compute at least one motion parameter from the vertical Doppler shift component.

6. The system of claim 5, further comprising a terrain-monitoring module for determining terrain characteristics from the images generated by the image-generation module, the speed-computation module being further configured to assess a suspension performance based at least in part on the terrain characteristics and the at least one motion parameter.

7. The system of claim 5, wherein the speed-computation module is further configured to assess a suspension performance based at least in part on a motion parameter.

8. The system of claim 1, wherein the SPR system comprises a ground-penetrating radar (GPR) system.

9. The system of claim 1, wherein the horizontal speed is computed based at least in part on Doppler spreading.

10. A method of navigation comprising the steps of:
computationally processing signals received from an SPR system integrated with a vehicle into images including subsurface features;
computationally determining a location based on the images and a library of reference SPR images;
extracting a Doppler shift from the signals from the SPR system; and
determining at least one of a vertical or a horizontal speed from the extracted Doppler shift.

11. The method of claim 10, wherein the signals are received by a plurality of antenna elements angled to produce a horizontal Doppler shift component during horizontal motion of the vehicle.

12. The method of claim 11, further comprising the step of computing a horizontal travel speed from the horizontal Doppler shift component.

13. The method of claim 10, wherein the signals are received by a plurality of antenna elements angled to produce a vertical Doppler shift component during vertical motion.

14. The method of claim 13, further comprising the step of computing at least one motion parameter from the vertical Doppler shift component.

15. The method of claim 14, further comprising the steps of:
determining terrain characteristics from the images; and
assessing a suspension performance based at least in part on the terrain characteristics and the at least one motion parameter.

16. The method of claim 10, wherein the SPR system comprises a ground-penetrating radar (GPR) system.

17. The method of claim 10, wherein the horizontal speed is computed based at least in part on Doppler spreading.
